(19) United States
(12) Patent Application Publication
(10) Pub. No.: US 2009/0288609 A1
(43) Pub. Date: Nov. 26, 2009

(54) Pet feeding vessel with barrier

(76) Inventor: Amy A. Leary, Melbourne, FL (US)

Correspondence Address: AMY A. LEARY, 173 Burlington Road, Harwinton, CT, 06791, US

(21) Appl. No.: 12/154,327

(22) Filed: May 22, 2008

(51) Int. Cl. A01K 5/01

(52) U.S. Cl. 119/61.5

(57) ABSTRACT

An pet feeding vessel with an upwardly elongated sidewall that acts as both an containment and protective barrier to the vessel. The feeding vessel has a designated maximum level to assure successful results from the intended functions of the design of this vessel. The apex is at the rear of the vessel and tapers in height at the sides of the top perimeter to the front of the vessel just above the designated fill level. The barrier functions serve to provide substantially more confinement area than common feeding bowls and vessels in proportion to the maximum filling level capacity. The additional confinement area present also serves to isolate the feeding animals and prevent other animals from accessing the food or water while one animal is feeding.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

A common occurrence when a pet feeds or drinks is a loss of food or water due to a lack of containment area above the contents placed in the feeding vessel.

Another common occurrence when feeding more than one animal or pet is a feeding frenzy when an animal attempts to feed from the same bowl, at the same time as another animal.

While there are feeding vessels known in prior art that provide for a raised portion to a feeding vessel, the disadvantage of prior art either requires the use of a support structure or is designed for a specific size of pet (e.g., a puppy) or provide only minimal effectiveness for containment of the vessel.

While there are feeding vessels in prior art that provide for a protection barrier to feeding pets, such protection is provided by a separate apparatus.

An advantage of the present invention is the provision of a feeding vessel comprising as one unit.

Another advantage of the present invention is the provision of a ridge to indicate a fill level for contents placed in the vessel.

Another advantage of the present invention is the upper portion of the sidewall has a substantial height, relative to the level of contents in the vessel, to provide an optimal barrier.

Still another advantage of the present invention is the upper portion of the sidewall serves a protection barrier to limit to one feeding pet at a time.

Still another advantage of the present invention is that a pet's head is positioned diagonally to the front of the vessel as opposed to the top of a vessel, allowing for substantial surface area of the protection and containment functions of the vessel and the pet.

Yet another advantage of the present invention is that the contents of food or water placed in the vessel is accessible to a wide range of pet sizes, a small dog may feed from the same bowl as a large or extra large breed dog at different intervals.

Yet another advantage of the present invention is the capability of nesting stacking with like vessels.

Thus several advantages of one or more aspects are to provide additional containment area to the invention. Other advantages of one or more aspects are to provide effective containment and protection to the contents of the vessel and to the feeding pet. These and other advantages of more aspects will become apparent from a consideration of the ensuing description and accompanying drawings.

### FIELD OF THE INVENTION

This application relates to a feeding vessel for household pets or animals and in particular to a feeding vessel with an upwardly oblong sidewall design to form a barrier above the feeding area. The vessel is of a unitary molded construction and is configured for nested stacking with like vessels.

### BRIEF DESCRIPTION OF THE SEVERAL VIEWS OF THE DRAWINGS

FIG. 1 is a front view of a pet feeding vessel with barrier.

FIG. 2 is a rear view thereof.

FIG. 3 is a left side view thereof.

FIG. 4 is a right side view thereof.

FIG. 5 is a top plan view thereof, and

FIG. 6 is a bottom plan view thereof.

I claim the utility design for a pet feeding vessel with barrier as shown.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

In practice, the feeding vessel with a designed opening is molded out of a conventional plastic such as, Lexan, Acrylic, ABS or more commonly polypropylene. It should be appreciated that a metal composite may also be used.

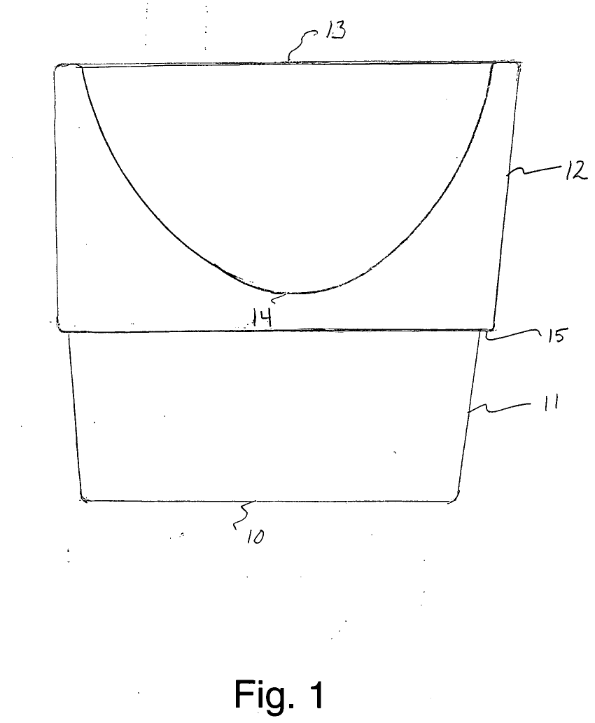

In the various views of the drawings, like reference characters designate like or similar parts throughout the several views, and more specifically to FIGS. 1-6. FIG. 1 represents a front view of the invention. Having a base 10 and an attached sidewall 11 around the outside perimeter of the base 10. Rim 15 is formed around the vessel by an increase of, ⅛″ to ½″, in the width of the diameter of the sidewall. Rim 15 is serves represent the suggested fill level for feed or water.

The sidewall apex 13 is centered at the rear of the top perimeter and has a height of 150% to 300% of the distance between the rim 15 and the base 10 and continues at the same height to the sides of the vessel and then tapering in height equally, both left and right 16 to the front of the vessel 14, above rim 15, to provide a containment and protection barrier 12.

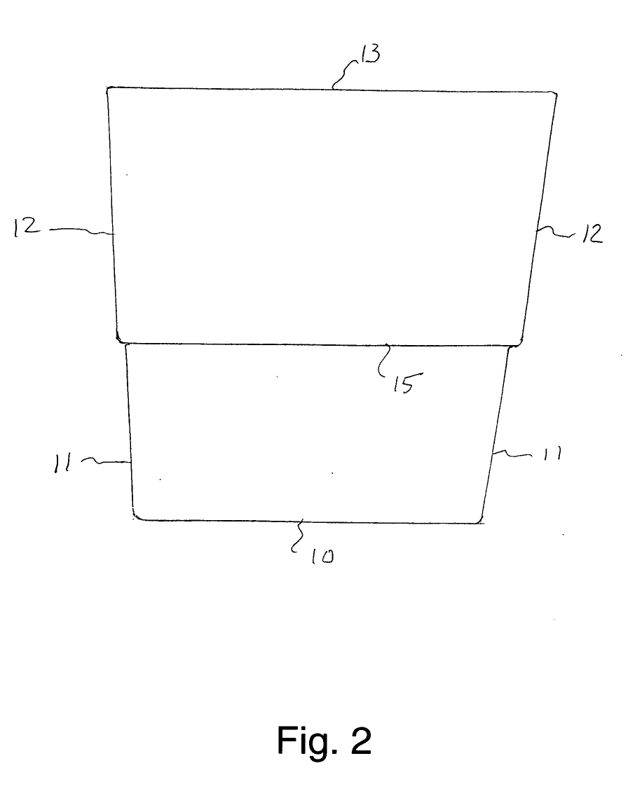

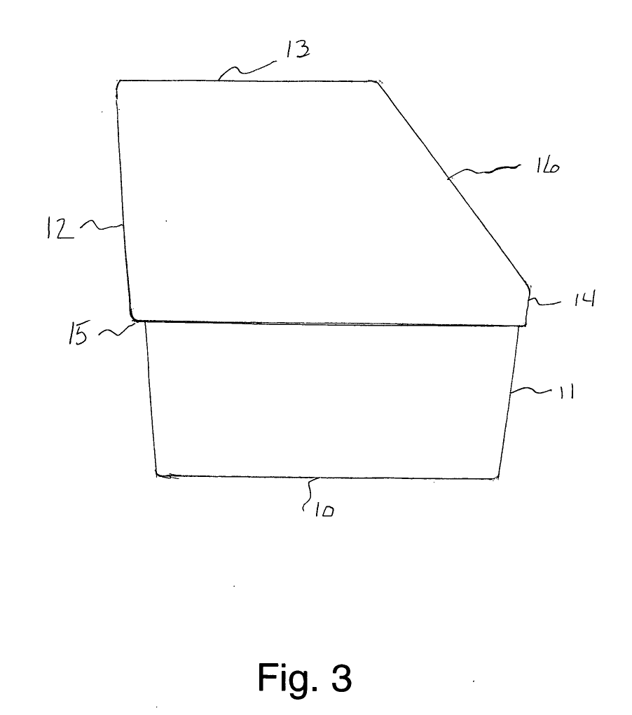

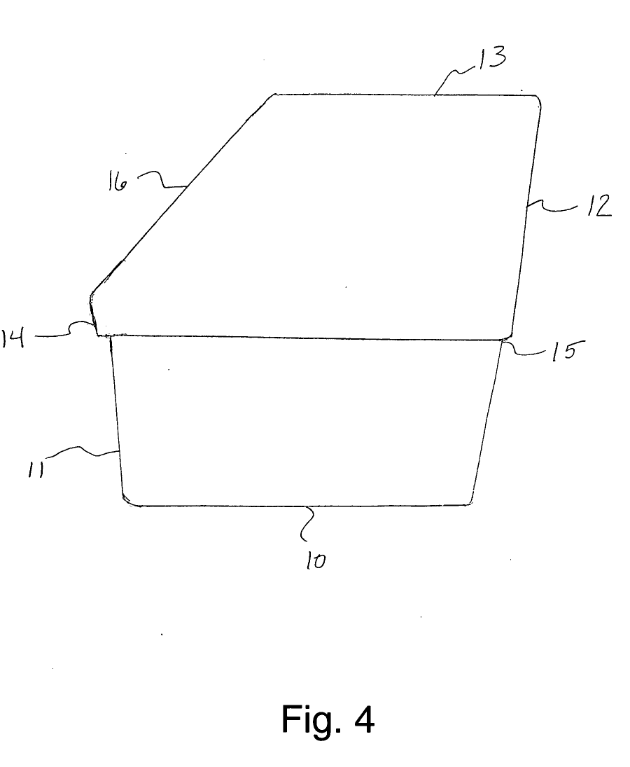

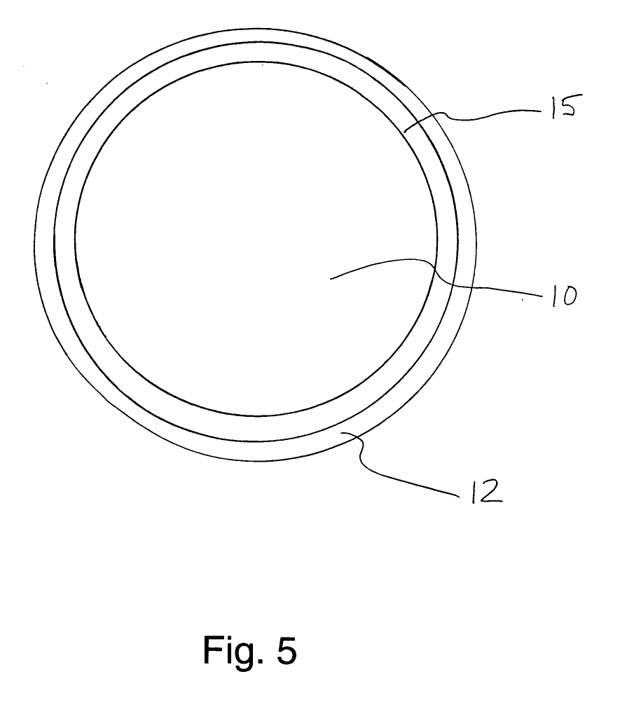

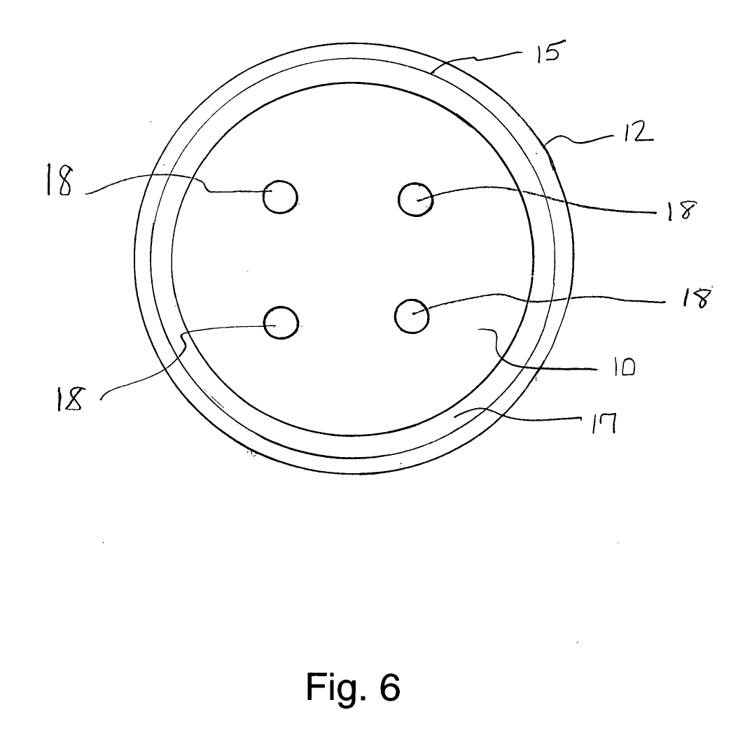

FIG. 2 represents a rear view of the invention for illustration of this perspective and contains the same embodiments as formerly presented. FIG. 3 represents a left view of the invention for illustration of this perspective and contains the same embodiments as formerly presented. FIG. 4 represents a right view of the invention for illustration of this perspective and contains the same embodiments as formerly presented. FIG. 5 represents a top view of the invention and illustrates the same embodiments as formerly presented. FIG. 6 represents a bottom view of the invention. The bottom portion of base 10 has been recessed a small amount to provide outer rim 17. Four circular protrusions 18 centered equally at the bottom of base 10 provides leverage. Rim 17 and protrusions 18 reduce surface to surface contact to reduce sliding during use.

While the present invention has been described at some length and with some particularity with respect to the several described embodiments, it is not intended that this should be limited to any such particulars or embodiments or a particular embodiment, but is to be construed with references to the appended claims so as to provide the broadest possible interpretation of such claims in view or prior art and, therefore, to effectively encompass the intended scope of the invention.

What is claimed as the invention is:

1. A pet feeding vessel, for placement on a surface, comprising as one unit, with a base and an attached upward sidewall, a ridge around the perimeter of said sidewall formed by an increase in the diameter of sidewall perpendicular to said base at a point predetermined to indicate the maximum fill level for feed or water, having the apex of said sidewall at the rear of said vessel with a total height of about 150% to 300% of the distance between said ridge and said base, with the total height of said sidewall gradually tapering in height 16 equally from the two sides of said vessel to the front of said vessel above 14 said ridge.

2. A pet feeding vessel in accordance with claim 1, whereas the presence of said sidewall above said ridge 12 acts as a containment barrier for said vessel.

3. A pet feeding vessel in accordance with claim 1, whereas the presence of said sidewall above said ridge 12 acts as a protective barrier for the pet feeding from said vessel.
